(19) United States
(12) Patent Application Publication
(10) Pub. No.: US 2024/0267711 A1
(43) Pub. Date: Aug. 8, 2024

(54) TECHNIQUES FOR SUPPORTING EMERGENCY SHORT MESSAGE SERVICE (SMS) MESSAGES UNDER LIMITED-SERVICE SCENARIOS

(71) Applicant: Apple Inc., Cupertino, CA (US)

(72) Inventors: Utkarsh KUMAR, Fremont, CA (US); Krisztian KISS, Hayward, CA (US); Samuel J. MILLER, San Jose, CA (US); Vivek G. GUPTA, San Jose, CA (US)

(21) Appl. No.: 18/540,684

(22) Filed: Dec. 14, 2023

Related U.S. Application Data
(60) Provisional application No. 63/483,718, filed on Feb. 7, 2023.

(51) Int. Cl. H04W 4/14; H04W 76/50

(52) U.S. Cl. CPC H04W 4/14; H04W 76/50; H04W 4/90

(57) ABSTRACT

This Application sets forth techniques for routing emergency (SMS) messages under limited-service scenarios. One technique can be implemented by a network entity associated with a mobile network operator (MNO), and include the steps of (1) receiving an SMS message from a wireless device, and (2) in response to determining that (i) the wireless device is communicatively coupled to the MNO under a limited-service connection due to being unaffiliated with the MNO, and (ii) a destination address of the SMS message corresponds to an emergency service: (a) identifying at least one emergency service provider that corresponds to the MNO, and (b) providing at least a portion of the SMS message to the emergency service provider.

### CROSS-REFERENCE TO RELATED APPLICATIONS

The present application claims the benefit of U.S. Provisional Application No. 63/483,718, entitled “TECHNIQUES FOR SUPPORTING EMERGENCY SHORT MESSAGE SERVICE (SMS) MESSAGES UNDER LIMITED-SERVICE SCENARIOS,” filed Feb. 7, 2023, the content of which is incorporated by reference herein in its entirety for all purposes.

### FIELD

The described embodiments set forth techniques for managing emergency short message service (SMS) messages issued by wireless devices that are operating under limited-service scenarios. In particular, the techniques include both service-side and device-side implementations that enable emergency SMS messages to be routed to appropriate emergency service providers under limited-service scenarios.

### BACKGROUND

Emergency texting services are being introduced in many countries around the world, and there are several examples of successful implementations. In the United States, for example, emergency texting services are available in many cities, and they have been used to report medical emergencies, fires, and robberies. Emergency texting services work by enabling users to send text messages to a special phone number that is linked to emergency service providers (e.g., “911” in the United States). Trained personnel ultimately receive the message and can aid in turn. In this regard, emergency texting services are a valuable addition and are likely to become more widely used in the future.

Emergency texting services work well when a given wireless device is able to access standard wireless services (e.g., data, voice, short message service (SMS)) provided by a mobile network operator (MNO) to which the wireless device is subscribed. However, various issues arise when the wireless device is operating under a limited-service scenario. A limited-service scenario can occur, for example, when the wireless device roams onto a network provided by a different MNO that is unobligated to provide standard wireless services—such as SMS messaging—to the wireless device. Instead, the wireless device is typically only permitted to place emergency calls, thereby limiting the number of options available to a user of the wireless device during potential emergencies. Consequently, the user may run into issues when attempting to send a text message to an emergency service if the wireless device is operating under a limited-service scenario.

In view of the foregoing considerations, there exists a need to improve the management of emergency text messages issued by wireless devices that are operating under limited-service scenarios.

### SUMMARY

This Application sets forth techniques for managing emergency short message service (SMS) messages issued by wireless devices that are operating under limited-service scenarios. In particular, the techniques include both service-side and device-side implementations that enable emergency SMS messages to be routed to appropriate emergency service providers under limited-service scenarios.

One embodiment sets forth a method for routing emergency (SMS) messages under limited-service scenarios. According to some embodiments, the method can be implemented by a network entity associated with a mobile network operator (MNO), and include the steps of (1) receiving an SMS message from a wireless device, and (2) in response to determining that (i) the wireless device is communicatively coupled to the MNO under a limited-service connection due to being unaffiliated with the MNO, and (ii) a destination address of the SMS message corresponds to an emergency service: (a) identifying at least one emergency service provider that corresponds to the MNO, and (b) providing at least a portion of the SMS message to the emergency service provider.

Another embodiment sets forth another method for routing emergency SMS messages under limited-service scenarios. According to some embodiments, the method can be implemented by a network entity associated with an MNO, and include the steps of (1) receiving, from a wireless device, a request to access wireless services provided by the MNO, and (2) in response to determining that the wireless device is unaffiliated with the MNO, providing, to the wireless device: (i) an indication that the MNO supports emergency SMS messages, and (ii) a short message service center (SMSC) address of an SMSC that corresponds to the MNO.

Yet another embodiment sets forth another method for routing emergency SMS messages under limited-service scenarios. According to some embodiments, the method can be implemented by a wireless device, and includes the steps of (1) providing, to a network entity associated with an MNO with which the wireless device is unaffiliated, a request to access wireless services provided by the MNO, (2) receiving, from the network entity: (i) an indication that the MNO supports emergency SMS messages, and (ii) an SMSC address of an SMSC that corresponds to the MNO, and (3) updating a configuration of the wireless device such that all SMS messages transmitted by the wireless device are assigned to the SMSC address.

Other embodiments include a non-transitory computer readable medium configured to store instructions that, when executed by a processor included in a computing device, cause the computing device to implement the methods and techniques described in this disclosure. Yet other embodiments include hardware computing devices that include processors that can be configured to cause the hardware computing devices to implement the methods and techniques described in this disclosure.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to implement the various techniques described herein, according to some embodiments.

FIG. 2 illustrates a block diagram of a more detailed view of particular components of a wireless device illustrated in FIG. 1, according to some embodiments.

FIG. 3A illustrates a method, implemented by a network entity, for routing emergency SMS messages under limited-service scenarios, according to some embodiments.

FIG. 3B illustrates a sequence diagram of the manner in which the various entities described in conjunction with FIG. 3A can implement the method of FIG. 3A, according to some embodiments.

FIG. 4 illustrates a method, implemented by a network entity, for an alternative approach (relative to the method of FIG. 3A) for routing emergency SMS messages under limited-service scenarios, according to some embodiments.

FIG. 5 illustrates a method, implemented by a wireless device, for the alternative approach (relative to the method of FIG. 3A and described in conjunction with FIG. 4) for routing emergency SMS messages under limited-service scenarios, according to some embodiments.

FIG. 6 illustrates a block diagram of exemplary elements of a mobile wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

A limited-service scenario can arise under a variety of situations, including when a wireless device (1) enters into a roaming condition with a “foreign” mobile network operator (MNO) that is distinct from a “primary” (i.e., home) MNO of the wireless device, and (2) there is no business agreement between the foreign MNO and the primary MNO that obligates the foreign MNO to provide wireless services to the wireless device. In some cases, a network entity (e.g., a server device) associated with the foreign MNO may receive a request from the wireless device to send an SMS message to an emergency service (e.g., 911 in the United States, 112 in Europe, and so on). When this occurs, it is in the best interest of society for the MNO to transmit the SMS message to an appropriate emergency service provider (notwithstanding the fact that the MNO is under no contractual obligation to do so).

SMS messages transmitted by a wireless device typically include at least (1) a source address (e.g., a phone number) associated with the wireless device, (2) a short message service center (SMSC) address of an SMSC associated with the home MNO, (3) a destination address (e.g., a phone number or short code) of a recipient to which the SMS message should be delivered, and (4) message content (e.g., text, images, etc.) to be delivered to the recipient. Typically, the SMSC address is a fixed value that is obtained from a Subscriber Identity Module (SIM) that is associated with the home MNO and accessible to the wireless device. In this regard, when a user attempts to send an SMS message while under the roaming condition described above, the SMS message will be addressed to the SMSC of the home MNO rather than an SMSC of the foreign MNO. Consequently, when emergency SMS messages are received, the foreign MNO is left with two options that each are problematic.

First, the foreign MNO can simply disregard the SMS message, which likely would exacerbate any peril that the user of the wireless device is experiencing. Second, the foreign MNO can route the SMS message to the SMSC of the home MNO (in accordance with the default/home SMSC address included in the SMS message). However, this approach is problematic given the roaming condition implies a geographical discrepancy between the current physical location of the user/wireless device relative to the physical location of the SMSC of the home MNO. In any case, the SMSC of the home MNO will attempt to route the SMS message to an emergency service provider that is geographically proximate to the SMSC of the home MNO (and presumably remote from the current physical location of the user/wireless device). Consequently, the emergency service provider would need to work with the user to identify an emergency service provider that is geographically proximate to the user—and then continue to function as an intermediary between the two—which also would likely exacerbate any peril that the user of the wireless device is experiencing.

Accordingly, the embodiments set forth techniques for managing emergency SMS messages issued by wireless devices that are operating under limited-service scenarios. In particular, the techniques include both service-side and device-side implementations that enable emergency SMS messages to be routed to appropriate emergency service providers under limited-service scenarios.

One embodiment sets forth a method implemented by a network entity associated with an MNO, and includes the steps of (1) receiving an SMS message from a wireless device, and (2) in response to determining that (i) the wireless device is communicatively coupled to the MNO under a limited-service connection due to being unaffiliated with the MNO, and (ii) a destination address of the SMS message corresponds to an emergency service: (a) identifying at least one emergency service provider that corresponds to the MNO, and (b) providing at least a portion of the SMS message to the emergency service provider.

According to some embodiments, the limited-service connection provides access to a first set of functionalities that is constrained relative to a second set of functionalities normally accessible to the wireless device when communicatively coupled to a primary MNO associated with the wireless device. For example, the first set of functionalities may only include emergency voice services and emergency SMS message services, whereas the second set of functionalities may include data services, voice services, and SMS message services.

According to some embodiments, the network entity can utilize any feasible approach to effectively determine that the destination address of the SMS message corresponds to an emergency service. For example, the network entity can perform a lookup of the destination address in a database of destination addresses of emergency service providers with which the network entity is capable of communicating.

In some embodiments, the SMS message includes an SMSC address of an SMSC that is (1) associated with the primary MNO, and (2) disregarded by the network entity. This beneficially enables the disclosed techniques to be implemented without modifying the configuration of the wireless device. In particular, the network entity is able to disregard the SMSC because it instead routes the SMS message to the emergency service (e.g., directly, or indirectly). However, it is noted that the network entity can simply route the SMS message to an SMSC that is geographically relevant to the wireless device (such as an SMSC that is associated with the network entity communicating with the wireless device). For example, the network entity can identify an SMSC that is geographically proximate to the current location of the wireless device and then route the SMS message to the SMSC. In turn, the SMSC can route the message to the appropriate emergency service provider.

Additionally, or alternatively, a configuration of the wireless device can be modified such that, prior to providing the SMS message to the network entity, the wireless device (1) detects that the destination address corresponds to the emergency service, and (2) excludes an SMSC field and corresponding value from the SMS message. Alternatively, the configuration of the wireless device can be modified such that, prior to providing the SMS message to the network entity, the wireless device (1) detects that the destination address corresponds to the emergency service, and (2) assigns a fixed value to an SMSC field, where the fixed value is unassociated with any SMSC. These approaches can be beneficial in that they can reduce the overall size of the SMS message and provide an additional way for the network identity to identify the SMS message as an emergency message. In particular, the network entity can interpret an excluded SMSC field or a fixed value assigned to the SMSC field as an indication that the wireless device has identified that an emergency context applies to the SMS message.

Another embodiment sets forth a method implemented by a network entity associated with an MNO, and includes the steps of (1) receiving, from a wireless device, a request to access wireless services provided by the MNO, and (2) in response to determining that the wireless device is unaffiliated with the MNO, providing, to the wireless device: (i) an indication that the MNO supports emergency SMS messages, and (ii) an SMSC address of an SMSC that corresponds to the MNO. Under this approach, the wireless device can, upon receiving the indication and the SMSC address, update a configuration such that the provided SMSC address effectively overrides a primary SMSC address of a home MNO that the wireless device normally utilizes when sending SMS messages. In this manner, SMS messages received by the network entity from the wireless device will be directed to the SMSC that corresponds to the MNO, where, in turn, the SMSC can route the SMS message to the appropriate emergency service provider.

According to some embodiments, the network entity can provide the indication and the SMSC address over a limited-service connection that is established with the wireless device (in response to determining that the wireless device is unaffiliated with the MNO). According to some embodiments, the network entity can provide, in addition to the indication and the SMSC address, destination address information for at least one emergency service that is available. This can enable the wireless device to display the destination address information in response to receiving a request to draft a first SMS message (relative to a time at which the wireless device provides the request to access wireless services provided by the MNO). This can be particularly helpful to inform a user of the wireless device of the emergency services that are available through SMS messaging.

Yet another embodiment sets forth a method implemented by a wireless device, and includes the steps of (1) providing, to a network entity associated with an MNO with which the wireless device is unaffiliated, a request to access wireless services provided by the MNO, (2) receiving, from the network entity: (i) an indication that the MNO supports emergency SMS messages, and (ii) an SMSC address of an SMSC that corresponds to the MNO, and (3) updating a configuration of the wireless device such that all SMS messages transmitted by the wireless device are assigned to the SMSC address. As previously described herein, under this approach the wireless device can, upon receiving the SMSC address, update a configuration such that the provided SMSC address effectively overrides a primary SMSC address of a home MNO that the wireless device normally utilizes when sending SMS messages.

According to some embodiments, the network entity can provide the indication and the SMSC address over a limited-service connection that is established with the wireless device. According to some embodiments, the wireless device can receive, from the network entity, destination address information for at least one emergency service. Again, this can enable the wireless device to, in response to receiving a request to draft a first SMS message relative to providing the request to the network entity, display the destination address information.

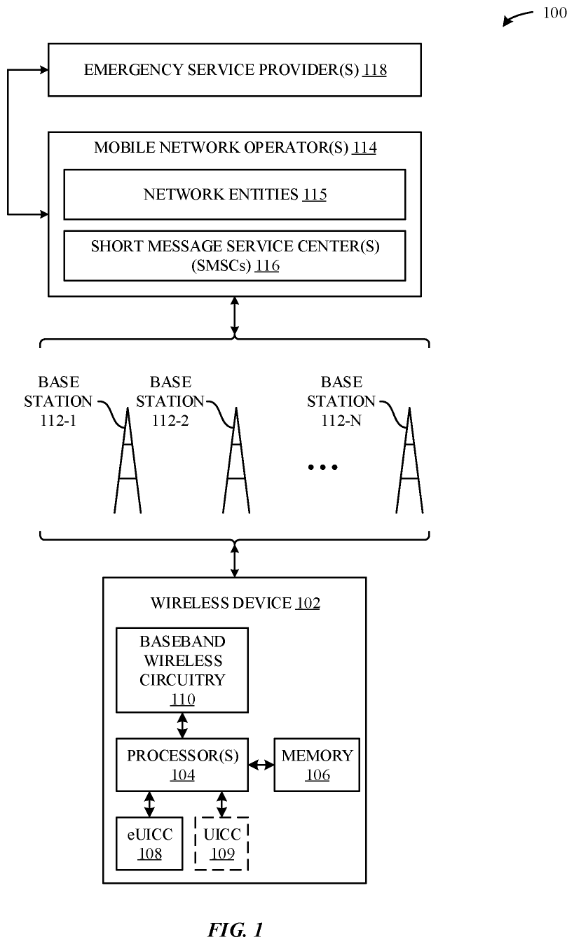

These and other embodiments are discussed below with reference to FIGS. 1 to 6; however, those skilled in the art will readily appreciate that the detailed description given herein with respect to these figures is for explanatory purposes only and should not be construed as limiting.

FIG. 1 illustrates a block diagram of different components of a system 100 that is configured to implement the various techniques described herein, according to some embodiments. More specifically, FIG. 1 illustrates a high-level overview of the system 100, which, as shown, includes a wireless device 102, which can also be referred to as a device, a wireless device, a mobile device, a user equipment (UE) and the like, a group of base stations 112-1 to 112-N that are managed by different Mobile Network Operators (MNOs) 114, and emergency service providers 118 that are in communication with the MNOs 114.

The wireless device 102 can represent a mobile computing device (e.g., an iPhone®, an iPad®, an Apple Watch by Apple®, etc.). The base stations 112-1 to 112-N can represent cellular wireless network units including evolved NodeBs (eNodeBs or eNBs) and/or next generation NodeBs (gNodeBs or gNB) that are configured to communicate with the wireless device 102. The MNOs 114 can represent different wireless service providers that provide specific cellular wireless services (e.g., voice, data, SMS, etc.) to which the wireless device 102 can subscribe, such as via a subscription account for a user of the wireless device 102. According to some embodiments, each MNO 114 can manage and/or be associated with various infrastructure units, including network entities 115 (used in conjunction with the base stations 112 to provide various wireless services offered by the MNO 114) and short message service centers (SMSCs) (used to facilitate transmission of SMS messages). Additional MNO infrastructure entities, such as those used for account management and billing, are not shown.

As shown in FIG. 1, the wireless device 102 can include processing circuitry, which can include one or more processor(s) 104 and a memory 106, at least one embedded Universal Integrated Circuit Card (eUICC) 108, and a baseband wireless circuitry 110 used for transmission and reception of cellular wireless radio frequency signals. The baseband wireless circuitry 110 can include analog hardware components, such as antennas and amplifiers, as well as digital processing components, such as signal processors (and/or general/limited purpose processors) and associated memory. In some embodiments, the wireless device 102 includes one or more physical UICCs 109, also referred to as Subscriber Identity Module (SIM) cards, in addition to or substituting for the eUICC 108. The components of the wireless device 102 work together to enable the wireless device 102 to provide useful features to a user of the wireless device 102, such as cellular wireless network access, non-cellular wireless network access, localized computing, location-based services, and Internet connectivity.

The eUICC 108 can be configured to store multiple electronic SIM (eSIM) profiles for accessing cellular wireless services provided by different MNOs 114 by connecting to their respective cellular wireless networks through base stations 112-1 to 112-N. For example, the eUICC 108 can be configured to store and manage one or more eSIM profiles for one or more MNOs 114 for different subscriptions to which the wireless device 102 is associated. To be able to access services provided by an MNO, an eSIM profile can be reserved for subsequent download and installation to the eUICC 108. In some embodiments, the eUICC 108 obtains one or more eSIM profiles from one or more associated MNO provisioning servers (not illustrated in FIG. 1). The MNO provisioning servers can be maintained by the MNOs 114, an OEM manufacturer, third party entities, and the like. Communication of eSIM profile data between an MNO provisioning server and the eUICC 108 (or between the MNO provisioning server and processing circuitry of the wireless device 102 external to the eUICC 108, e.g., the processor 104) can use a secure communication channel.

According to some embodiments, a given emergency service provider 118 can represent an entity capable of providing emergency services to users (e.g., a 911 call center in the United States, a 112 call center in Europe, and so on). According to some embodiments, one or more of the MNOs 114 can be configured to communicate with one or more of the emergency service providers 118 without utilizing one or more SMSCs 116 (although SMSCs can still be utilized, if desired, as described herein). This capability can be achieved using any acceptable approach, e.g., a direct line of communication, an indirect line of communication, and so on, using any communications protocol(s), between the emergency service providers 118 and the MNOs 114. In this manner, the MNOs 114 can, under limited-service scenarios, function as intermediaries between emergency service providers 118 and wireless devices 102, where the utilization of SMSCs 116 might otherwise raise any of the various issues described herein. Under an alternative approach—which, as described herein, can involve a wireless device 102 receiving an SMSC address an SMSC 116 associated with an MNO 114 through which the wireless device 102 operating under a limited-service scenario—the SMSC 116 can function as the intermediary between the wireless device 102 and the appropriate emergency service provider 118.

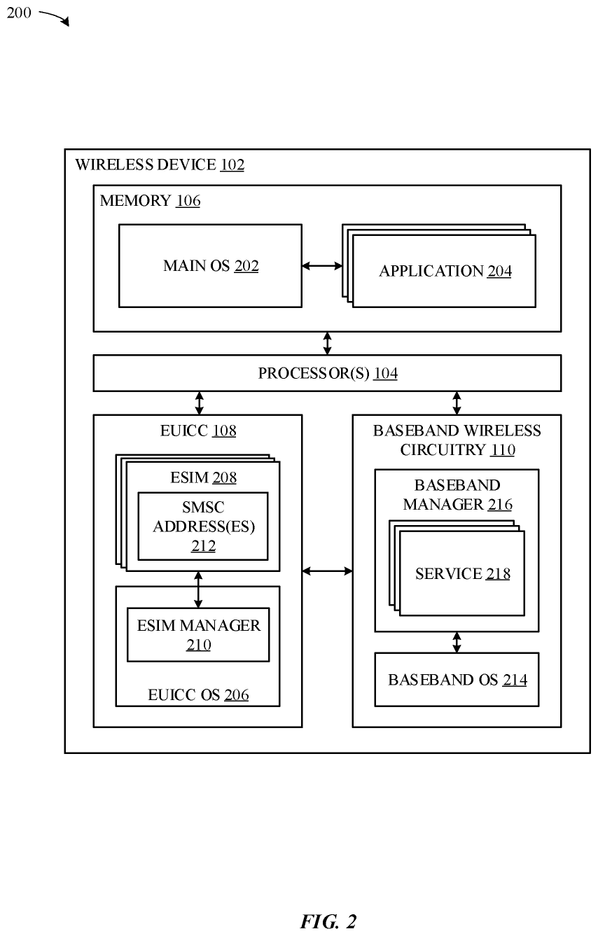

FIG. 2 illustrates a block diagram of a more detailed view 200 of particular components of the wireless device 102 of FIG. 1, according to some embodiments. As shown in FIG. 2, the processor(s) 104, in conjunction with memory 106, can implement a main operating system (OS) 202 that is configured to execute applications 204 (e.g., native OS applications and user applications). As also shown in FIG. 2, the eUICC 108 can be configured to implement an eUICC OS 206 that is configured to manage hardware resources of the eUICC 108 (e.g., a processor and a memory embedded in the eUICC 108). The eUICC OS 206 can also be configured to manage eSIM profiles 208 that are stored by the eUICC 108, e.g., by downloading, installing, deleting, enabling, disabling, modifying, or otherwise performing management of the eSIM profiles 208 within the eUICC 108 and to provide baseband wireless circuitry 110 with access to the eSIM profiles 208 to provide access to wireless services for the wireless device 102. The eUICC 108 OS can include an eSIM profile manager 210, which can perform management functions for various eSIM profiles 208. According to the illustration shown in FIG. 2, each eSIM profile 208 can include a number of SMSC addresses 212 associated with SMSCs 116 of the MNO to which the eSIM profile 208 corresponds. It is noted that each SMSC address 212 is distinct from the destination (i.e., recipient) address (e.g., a phone number, short code, etc.) to which the SMS message should be delivered. Although not illustrated in FIG. 2, each eSIM profile 208 can also implement one or more applets that, in conjunction with baseband wireless circuitry 110 and the eUICC 108, can enable the wireless device 102 to communicate with an MNO 114 and provide useful features to a user of the wireless device 102.

As also shown in FIG. 2, the baseband wireless circuitry 110 of the wireless device 102 can include a baseband OS 214 that is configured to manage hardware resources of the baseband wireless circuitry 110 (e.g., a processor, a memory, different radio components, etc.). According to some embodiments, the baseband wireless circuitry 110 can implement a baseband manager 216 that is configured to interface with the eUICC 108 to establish a secure channel with an MNO provisioning server and obtain information (such as eSIM profile data) from the MNO provisioning server for purposes of managing eSIM profiles 208. The baseband manager 216 can be configured to implement services 218, which represents a collection of software modules that are instantiated by way of the various applets of enabled eSIM profiles 208 that are included in the eUICC 108. For example, services 218 can be configured to manage different connections between the wireless device 102 and MNOs 114 according to the different eSIM profiles 208 that are enabled within the eUICC 108.

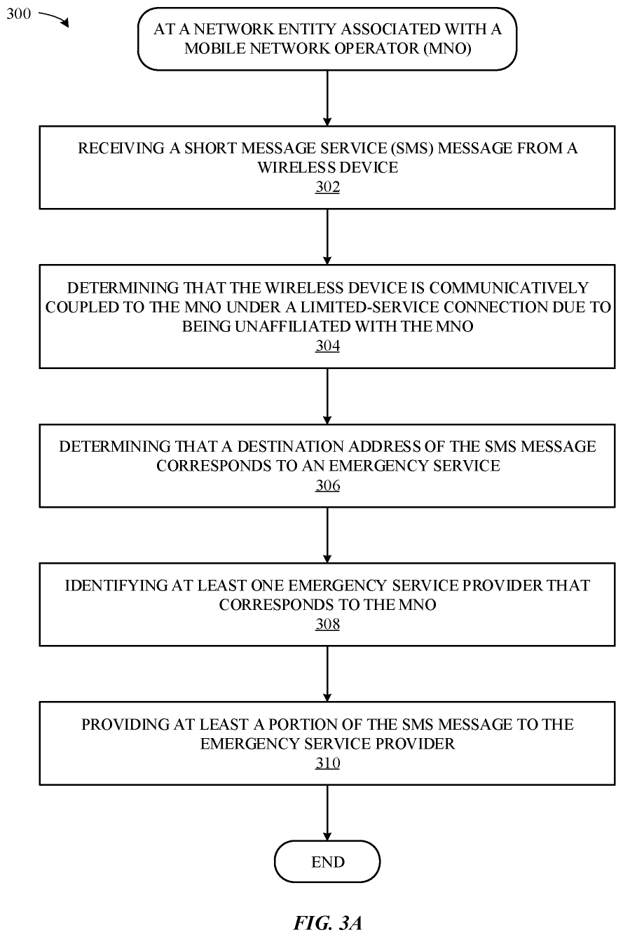

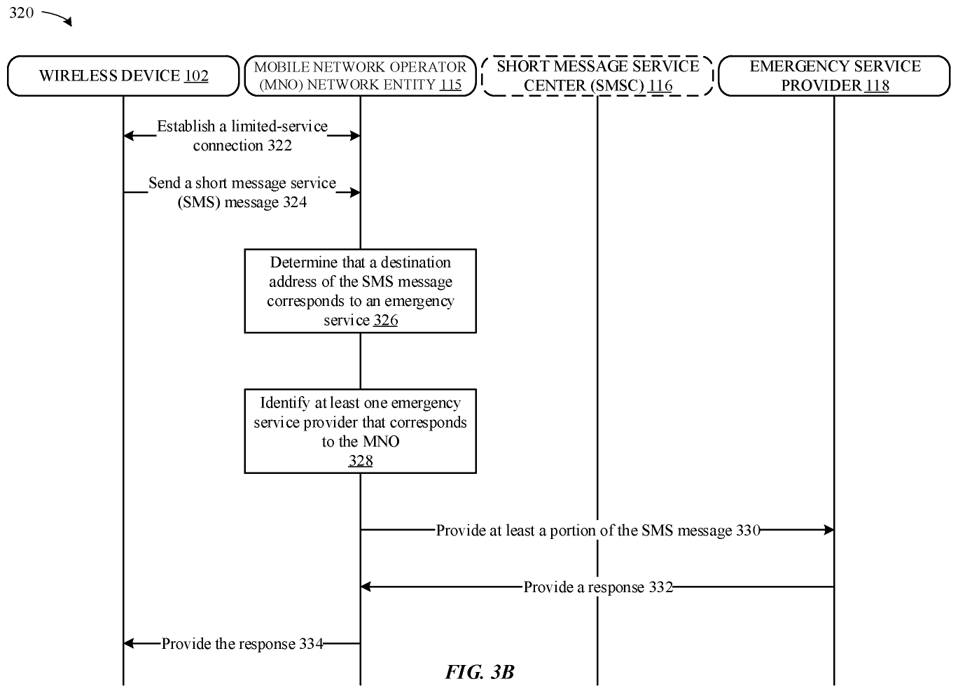

Accordingly, FIGS. 1-2 set forth block diagrams of various entities that can be utilized to implement the techniques described herein. A more detailed discussion of these techniques—particularly, the manner in which the various entities of FIGS. 1-2 can work together—will now be discussed below in conjunction with FIGS. 3A-3B, 4, and 5.

FIG. 3A illustrates a method 300 for routing emergency SMS messages under limited-service scenarios, according to some embodiments. According to some embodiments, the method 300 can be implemented by a network entity 115 of an MNO 114, such that configuration changes to the wireless device 102 are unnecessary. As shown in FIG. 3A, the method 300 begins at step 302, where the network entity 115 receives an SMS message from a wireless device 102. The wireless device 102 can transmit the SMS message in conjunction with or subsequent to establishing a communications channel with the network entity 115/MNO 114, e.g., under a roaming scenario, where the MNO 114 constitutes a “foreign” MNO 114 that is unaffiliated with the wireless device 102 and that is not under contractual obligation to provide wireless services otherwise provided by a “home” MNO 114 that is affiliated with the wireless device 102.

At step 304, the network entity 115 determines that the wireless device 102 is communicatively coupled to the MNO 114 under a limited-service connection due to being unaffiliated with the MNO 114. Moreover, at step 306, the network entity 115 determines that a destination address of the SMS message corresponds to an emergency service. Steps 304 and 306 constitute relevant determinations in that the MNO 114 may choose to act on the SMS message if it is emergency-based, notwithstanding the fact that the limited-service connection yields the MNO 114 under no contractual obligation to do so.

At step 308, the network entity 115 identifies at least one emergency service provider 118 that corresponds to the MNO 114. According to some embodiments, this step can involve the network entity 115 performing a lookup of the destination address (identified in step 306) in a database of destination addresses of emergency service providers emergency service provider 118 with which the network entity 115 is capable of communicating. As described above in conjunction with FIG. 1, this can involve identifying emergency service providers 118 with which the network entity 115 has a direct line of communication, an indirect line of communication, and so on.

Additionally, it is noted that the network entity 115 can analyze any information that is accessible to the network entity 115, at any level of granularity, when performing step 308 to help narrow on appropriate emergency service providers 118. For example, the network entity 115 can be configured to identify an emergency service provider 118 that is most proximate to the current location of the wireless device 102 (e.g., as determined by the wireless device 102 itself, the network entity 115, or some other entity). In another example, the network entity 115 can be configured to analyze message content of the SMS message to obtain additional context about the nature of the emergency—which, in turn, can be used to narrow on an appropriate emergency service provider 118. For example, if the network entity 115 detects the term “fire” (or some other word or phrase that is fire-related), then the network entity 115 can narrow on emergency service providers 118 that specialize in fire services. In another example, if the network entity 115 detects the term “robbery” (or some other word or phrase that is robbery-related), then the network entity 115 can narrow on emergency service providers 118 that interface with police services. It is noted that the foregoing examples are not meant to be limiting. It is also noted that the network entity 115 can adjust or exclude any of the foregoing analyses in accordance with privacy rules that are to be enforced.

At step 310, the network entity 115 provides at least a portion of the SMS message to the emergency service provider 118. For example, the network entity 115 can extract, from the SMS message, (1) a source address (e.g., a phone number) associated with the wireless device 102, (2) a destination address (e.g., a phone number or short code) associated with an emergency service, and (3) message content, and provide this information to the emergency service provider 118. It is noted that the network entity 115 can provide additional information not included in the SMS message that may be helpful to the emergency service provider 118, such as the current location of the wireless device 102, the time at which the emergency service provider 118 received the SMS message, the current signal strength observed between the wireless device 102 and at least one base station 112 through which the wireless device 102 and the network entity 115 are communicating, and so on. It is noted that the foregoing examples are not meant to be limiting, and that any amount/type of information, at any level of granularity, can be provided to the emergency service provider 118 without departing from the scope of this disclosure.

In any case—and, as described above—the network entity 115 can utilize the appropriate channels for providing the foregoing information to the emergency service provider 118, such as a direct line of communication, an indirect line of communication, and the like. In turn—and although not illustrated in FIG. 3A—the network entity 115 can receive a response from the emergency service provider 118 and provide the response to the wireless device 102. These steps can then be repeated any number of times to enable communications between a user of the wireless device 102 and the emergency service provider 118 to take place as appropriate.

FIG. 3B illustrates a sequence diagram 320 of the manner in which the various entities described above in conjunction with FIG. 3A can implement the method 300, according to some embodiments. As shown in FIG. 3B, the sequence diagram 320 begins at step 322, which involves the wireless device 102 establishing a limited-service connection with the network entity 115 (in accordance with the various techniques described herein). At step 324, the wireless device 102 sends an SMS message to the network entity 115. The SMS message can be sent, for example, after a user of the wireless device 102 drafts an SMS message that is directed to an emergency service and that explains the nature of the emergency.

At step 326, the network entity 115 determines that a destination address of the SMS message corresponds to an emergency service (e.g., using the techniques described above in conjunction with step 306 of FIG. 3A). At step 328, the network entity 115 identifies at least one emergency service provider 118 that corresponds to the MNO (e.g., using the techniques described above in conjunction with step 308 of FIG. 3A). At step 330, the network entity 115 provides at least a portion of the SMS message to the emergency service provider 118 (e.g., using the techniques described above in conjunction with step 310 of FIG. 3A). As shown in FIG. 3B, step 330 can be performed without utilizing an SMSC 116 (of the “home” MNO 114 or otherwise) (although SMSCs 116 can still be utilized, if desired, as described herein).

In turn, at step 332, the emergency service provider 118 can provide a response to the network entity 115 (e.g., as described above in conjunction with FIG. 3A). Again, as shown in FIG. 3B, step 332 can be performed without utilizing an SMSC 116 (of the “home” MNO 114 or otherwise) (although SMSCs can still be utilized, if desired, as described herein). At step 334, the network entity 115 can provide the response to the wireless device 102. Steps 324-334 can then be repeated to enable communications between a user of the wireless device 102 and the emergency service provider 118 to take place as appropriate.

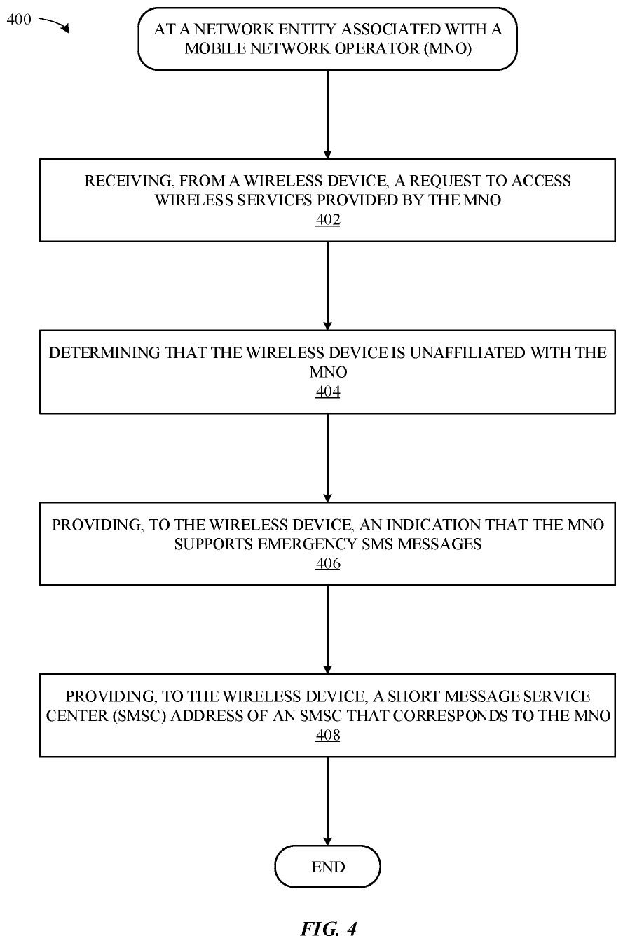

FIG. 4 illustrates a method 400 for an alternative approach (relative to the method 300 of FIG. 3A) for routing emergency SMS messages under limited-service scenarios, according to some embodiments. In particular—and, unlike the techniques described above in conjunction with FIGS. 3A-3B—this alternative approach can involve the utilization of SMSCs 116. According to some embodiments, the method 400 can be implemented by a network entity 115 of an MNO 114.

As shown in FIG. 4, the method 400 begins at step 402, where the network entity 115 receives, from a wireless device 102, a request to access wireless services provided by the MNO 114 (e.g., under a roaming scenario, as described herein). At step 404, the network entity 115 determines that the wireless device 102 is unaffiliated with the MNO 114. This can involve, for example, the network entity 115 identifying that the wireless device 102 is affiliated with a “home” MNO 114 having subscribers that the MNO 114 is not contractually obligated to support. In another example, the network entity 115 can identify that there is a contractual obligation to support some subscribers of the “home” MNO 114, but that the wireless device 102 is not among those subscribers. It is noted that the foregoing examples are not meant to be limiting, and that step 404 can involve the network entity 115 effectively identifying that it is under no obligation to provide wireless services that the wireless device 102 normally obtains through its “home” MNO 114 (e.g., data, voice, SMS, etc.).

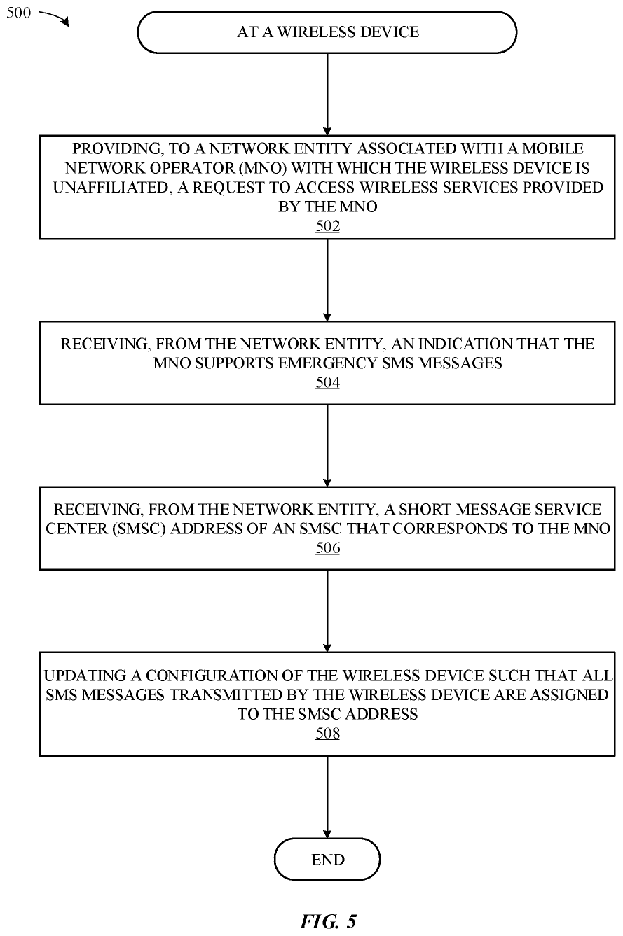

At step 406, the network entity 115 provides, to the wireless device 102, an indication that the MNO 114 supports emergency SMS messages. This indication can be beneficial in that it puts the wireless device 102 on notice that, although access to standard wireless services will not be available, access to emergency services will nonetheless be available. At step 408, the network entity 115 provides, to the wireless device 102, a short message service center (SMSC) address of an SMSC 116 that corresponds to the MNO 114. Consequently, steps 406 and 408 can result in the wireless device 102 updating a configuration so that the SMSC address provided by the network entity 115 effectively overrides any existing SMSC address utilized by the wireless device 102 when sending SMS messages. In this manner, all SMS messages, such as emergency SMS messages, will be routed to the SMSC 116 of the MNO 114, which presumably is geographically proximate/relevant to the wireless device 102. In turn, the SMSC 116 (and/or other entities) can route such emergency SMS messages to the appropriate emergency service providers 118. A more detailed explanation of the manner in which the wireless device 102 updates its configuration is provided below in conjunction with FIG. 5.

FIG. 5 illustrates a method 500 for the alternative approach (relative to the method 300 of FIG. 3A and described above in conjunction with FIG. 4) for routing emergency SMS messages under limited-service scenarios, according to some embodiments. According to some embodiments, the method 500 can be implemented by a wireless device 102 that is attempting to send an emergency SMS message through an MNO 114. As shown in FIG. 5, the method 500 begins at step 502, where the wireless device 102 provides, to a network entity 115 associated with an MNO 114 with which the wireless device is unaffiliated, a request to access wireless services provided by the MNO 114 (e.g., as described above in conjunction with step 402 of FIG. 4).

At step 504, the wireless device 102 receives, from the network entity 115, an indication that the MNO 114 supports emergency SMS messages (e.g., as described above in conjunction with step 406 of FIG. 4). At step 506, the wireless device 102 receives, from the network entity 115, an SMSC address of an SMSC 116 that corresponds to the MNO 114 (e.g., as described above in conjunction with step 408 of FIG. 4). At step 508, the wireless device 102 updates a configuration of the wireless device 102 such that all SMS messages transmitted by the wireless device 102 are assigned to the SMSC address received at step 506. In this manner, the wireless device 102 effectively overrides the SMSC address of the “home” SMSC 116 affiliated with the “home” MNO 114 to which the wireless device 102 is subscribed. Again, this helps mitigate the various issues described herein that might otherwise occur if emergency SMS messages sent by the wireless device 102 were routed to the “home” SMSC 116.

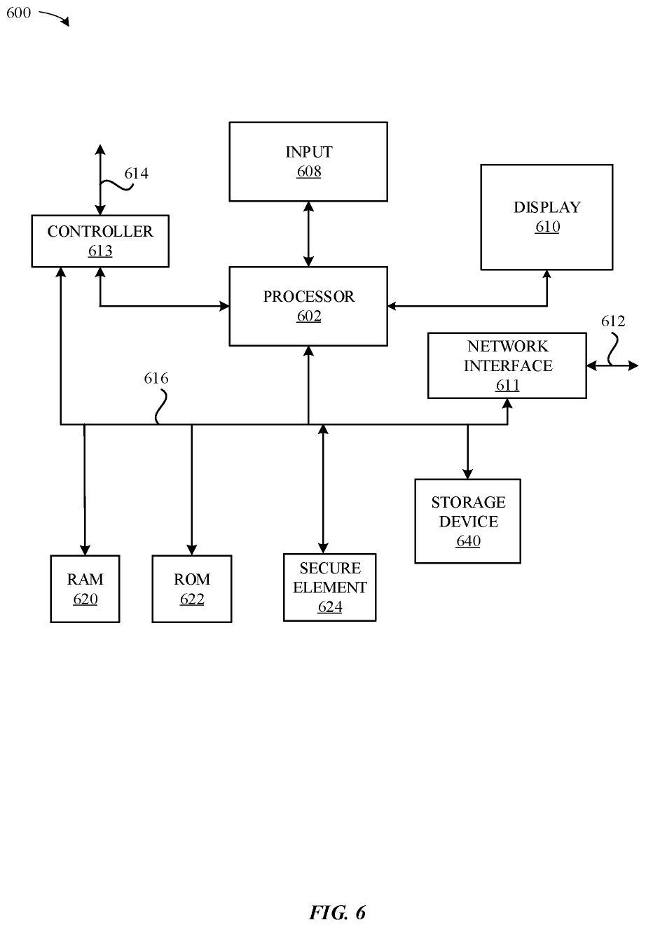

FIG. 6 illustrates a detailed view of a representative computing device 600 that can be used to implement various methods described herein, according to some embodiments. In particular, the detailed view illustrates various components that can be included in a wireless device 102. As shown in FIG. 6, the computing device 600 can include a processor 602 that represents a microprocessor or controller for controlling the overall operation of computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Still further, the computing device 600 can include a display 610 that can be controlled by the processor 602 to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that communicatively couples to a data link 612. In the case of a wireless connection, the network/bus interface 611 can include a wireless transceiver.

The computing device 600 also includes a storage device 640, which can comprise a single disk or a plurality of disks (e.g., hard drives), and includes a storage management module that manages one or more partitions within the storage device 640. In some embodiments, storage device 640 can include flash memory, semiconductor (solid state) memory or the like. The computing device 600 can also include a Random Access Memory (RAM) 620 and a Read-Only Memory (ROM) 622. The ROM 622 can store programs, utilities or processes to be executed in a non-volatile manner. The RAM 620 can provide volatile data storage, and stores instructions related to the operation of the computing device 600. The computing device 600 can further include a secure element (SE) 624, such as an eUICC 108, a UICC 109, or another secure storage for cellular wireless system access by a wireless device 102.

### Wireless Terminology

In accordance with various embodiments described herein, the terms “wireless communication device,” “wireless device,” “mobile wireless device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) Long Term Evolution (LTE), LTE Advanced (LTE-A), and/or 5G or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode UE can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High-Speed Packet Access (HSPA+) network or a Code Division Multiple Access (CDMA) 2000 Evolution-Data Only (EV-DO) network, when LTE and LTE-A networks are otherwise unavailable.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for routing emergency short message service (SMS) messages under limited-service scenarios, the method comprising, by a network entity associated with a mobile network operator (MNO):
receiving an SMS message from a wireless device; and
in response to determining that (1) the wireless device is communicatively coupled to the MNO under a limited-service connection due to being unaffiliated with the MNO, and (2) a destination address of the SMS message corresponds to an emergency service:
identifying at least one emergency service provider that corresponds to the MNO, and
providing at least a portion of the SMS message to the emergency service provider.

2. The method of claim 1, wherein the SMS message is routed to the emergency service provider without utilizing any short message service center (SMSC).

3. The method of claim 1, wherein the limited-service connection provides access to a first set of functionalities that is constrained relative to a second set of functionalities normally accessible to the wireless device when communicatively coupled to a primary MNO associated with the wireless device.

4. The method of claim 3, wherein the SMS message includes an SMSC address of an SMSC that is:
associated with the primary MNO, and
disregarded by the network entity.

5. The method of claim 1, wherein, prior to providing the SMS message to the network entity, the wireless device:
detects that the destination address corresponds to the emergency service, and
excludes an SMSC field and corresponding value from the SMS message.

6. The method of claim 1, wherein, prior to providing the SMS message to the network entity, the wireless device:
detects that the destination address corresponds to the emergency service, and
assigns a fixed value to an SMSC field, wherein the fixed value is unassociated with any SMSC.

7. The method of claim 1, wherein determining that the destination address of the SMS message corresponds to an emergency service comprises:
performing a lookup of the destination address in a database of destination addresses of emergency service providers with which the network entity is capable of communicating.

8. A method for routing emergency short message service (SMS) messages under limited-service scenarios, the method comprising, by a network entity associated with a mobile network operator (MNO):
receiving, from a wireless device, a request to access wireless services provided by the MNO; and
in response to determining that the wireless device is unaffiliated with the MNO,
providing, to the wireless device:
an indication that the MNO supports emergency SMS messages, and
a short message service center (SMSC) address of an SMSC that corresponds to the MNO.

9. The method of claim 8, further comprising, in conjunction with providing the indication and the SMSC address:
establishing a limited-service connection with the wireless device.

10. The method of claim 9, wherein the limited-service connection provides access to a first set of functionalities that is constrained relative to a second set of functionalities normally accessible to the wireless device when communicatively coupled to a primary MNO associated with the wireless device.

11. The method of claim 10, wherein the SMSC address overrides a primary SMSC address associated with the primary MNO.

12. The method of claim 11, wherein the indication causes the wireless device to update a configuration such that all SMS messages are assigned to the SMSC address.

13. The method of claim 8, wherein the network entity further provides, to the wireless device:
destination address information for at least one emergency service.

14. The method of claim 13, wherein the wireless device displays the destination address information in response to receiving a second request to draft a first SMS message relative to providing the request to the network entity.

15. A method for routing emergency short message service (SMS) messages under limited-service scenarios, the method comprising, by a wireless device:
providing, to a network entity associated with a mobile network operator (MNO) with which the wireless device is unaffiliated, a request to access wireless services provided by the MNO;
receiving, from the network entity:
an indication that the MNO supports emergency SMS messages, and
a short message service center (SMSC) address of an SMSC that corresponds to the MNO; and
updating a configuration of the wireless device such that all SMS messages transmitted by the wireless device are assigned to the SMSC address.

16. The method of claim 15, further comprising, in conjunction with receiving the indication and the SMSC address:
establishing a limited-service connection with the network entity.

17. The method of claim 16, wherein the limited-service connection provides access to a first set of functionalities that is constrained relative to a second set of functionalities normally accessible to the wireless device when communicatively coupled to a primary MNO associated with the wireless device.

18. The method of claim 17, wherein the SMSC address overrides a primary SMSC address associated with the primary MNO.

19. The method of claim 15, further comprising:
receiving, from the network entity:
destination address information for at least one emergency service.

20. The method of claim 19, further comprising, in response to receiving a second request to draft a first SMS message relative to providing the request to the network entity:
displaying the destination address information.
